(19) United States
(12) Patent Application Publication
(10) Pub. No.: US 2017/0020078 A1
(43) Pub. Date: Jan. 26, 2017

(54) Cross Flow Aeration System

(71) Applicant: Gatco Manufacturing Inc., Swift Current (CA)

(72) Inventor: Gary A. Schreiner, Saskatoon (CA)

(21) Appl. No.: 15/205,585

(22) Filed: Jul. 8, 2016

Related U.S. Application Data
(63) Continuation of application No. 13/951,816, filed on Jul. 26, 2013.
Application No. 13/951,816 is a continuation-in-part of application No. 12/931,691, filed on Feb. 8, 2011, now Pat. No. 8,677,648.

(51) Int. Cl. A01F 25/22; B65D 88/74

(52) U.S. Cl. CPC A01F 25/22; B65D 88/742

(57) ABSTRACT

A cross flow aeration system for aerating particulate materials disposed in a storage bin. The aeration system comprises a plurality of elongated hollow aerators. Each aerator is disposed inside the storage bin in proximity to an inside wall thereof having a substantially vertical orientation and has at least an opening for transmitting air from inside the aerator to the particulate materials. At least a blowing mechanism is in fluid communication with the plurality of aerators for providing the air thereto. At least an aerator air flow control mechanism may be disposed in each of the plurality of aerators for controlling flow of the air between a bottom section and a top section thereof. An elongated perforated venting tube is disposed approximately centrally within the storage bin. The venting tube extends generally upwardly to the bin roof for transmitting the air from the particulate materials to the bin roof and venting the same therefrom to a location external the storage bin.

This application is a continuation of application Ser. No. 13/951816 filed Jul. 26, 2013 which is a continuation in part of application Ser. No. 12/931691 filed Feb. 8, 2011 now issued to U.S. Pat. No. 8,677,648 on Mar. 25, 2014.

### FIELD

The present invention relates to aeration of particulate materials, and more particularly to an aeration system for aerating particulate materials disposed in a storage bin.

### BACKGROUND

After harvest, grain such as, for example, wheat, rye, barley, canola, or soybeans, is stored in storage bins on site at a farm or in large commercial storage facilities—prior distribution for processing or sale. Typically, the grain is stored in the storage bins during fall and winter.

Temperature changes due to changing seasons result in an unequal temperature distribution within the grain stored inside the storage bin causing natural convection of air through the grain and causing moisture to migrate therewith. The moisture then gathers in the top portion of the stored grain causing it to spoil. Depending on the temperature and the moisture content of the grain spoilage occurs within weeks or even days.

To prevent spoilage of grain stored in storage bins grain aeration systems or grain drying systems are employed for providing outside air into and through the stored grain. A major problem in aerating or drying grain stored in tall storage bins is that state of the art systems require provision of airflow at very high static pressure in order to push the air upwardly through the body of grain, resulting in the employment of very powerful fans with the associated high power consumption to achieve sufficient aeration.

It is desirable to provide an aeration system for aerating particulate materials disposed in a storage bin that has reduced power consumption while providing sufficient aeration.

It is also desirable to provide an aeration system for aerating particulate materials disposed in a storage bin that requires a substantially reduced static pressure of the provided airflow.

It is also desirable to provide an aeration system for aerating particulate materials disposed in a storage bin that enables control of the airflow in order to optimize air flow in a partially full storage bin, or to balance air flow between the upper and lower regions of a full storage bin.

It is also desirable to provide an aeration system for aerating particulate materials disposed in a storage bin that enables switching between a first mode of operation based on forced convection and a second mode of operation based on natural convection.

### SUMMARY

Accordingly, one object of the present invention is to provide an aeration system for aerating particulate materials disposed in a storage bin that has reduced power consumption while providing sufficient aeration.

Another object of the present invention is to provide an aeration system for aerating particulate materials disposed in a storage bin that requires a substantially reduced static pressure of the provided airflow.

Another object of the present invention is to provide an aeration system for aerating particulate materials disposed in a storage bin that enables control of the airflow in order to optimize air flow in a partially full storage bin, or to balance air flow between the upper and lower regions of a full storage bin.

Another object of the present invention is to provide an aeration system for aerating particulate materials disposed in a storage bin that enables switching between a first mode of operation based on forced convection and a second mode of operation based on natural convection.

According to one aspect of the present invention, there is provided a cross flow aeration system for aerating particulate materials disposed in a storage bin. The aeration system comprises a plurality of elongated hollow aerators. Each aerator is disposed inside the storage bin in proximity to an inside wall thereof having a substantially vertical orientation and has at least an opening for transmitting air from inside the aerator to the particulate materials. At least a blowing mechanism is in fluid communication with the plurality of aerators for providing the air thereto. At least an aerator air flow control mechanism may be disposed in each of the plurality of aerators for controlling flow of the air between a bottom section and a top section thereof. An elongated perforated venting tube is disposed approximately centrally within the storage bin. The venting tube-extends generally upwardly to the bin roof for transmitting the air from the particulate materials to the bin roof and venting the same therefrom to a location external the storage bin.

According to another aspect of the present invention, there is provided a method for aerating particulate materials disposed in a storage bin. A plurality of elongated hollow aerators is provided. Each aerator is disposed inside the storage bin in proximity to an inside wall thereof having a substantially vertical orientation. An elongated perforated venting tube is disposed approximately centrally within the storage bin. The venting tube extends generally upwardly to the bin roof. Air is provided to a bottom end portion of each of the aerators using at least a blowing mechanism. The air is transmitted from inside the aerators to the particulate materials. Using the venting tube the air is transmitted from the particulate materials to the bin roof and vented therefrom to a location external the storage bin. The transmission of the air to the particulate materials is controlled by controlling the airflow between sections of each of the aerators.

According to another aspect of the present invention, there is provided a method for aerating particulate materials disposed in a storage bin. A plurality of elongated hollow aerators is provided. Each aerator is disposed inside the storage bin in proximity to an inside wall thereof having a substantially vertical orientation. An elongated perforated venting tube is disposed approximately centrally within the storage bin. The venting tube extends generally upwardly to the bin roof. Air is provided to each of the aerators. The air is transmitted from inside the aerators to the particulate materials. Using the venting tube the air is transmitted from the particulate materials to the bin roof and vented therefrom to a location external the storage bin. The air is provided to a bottom end portion of each of the aerators in a first mode of operation by forced convection and to a top portion of each of the aerators in a second mode of operation by natural convection.

An advantage of the present invention is that it provides an aeration system for aerating particulate materials disposed in a storage bin that has reduced power consumption while providing sufficient aeration.

A further advantage of the present invention is that it provides an aeration system for aerating particulate materials disposed in a storage bin that requires a substantially reduced static pressure of the provided airflow.

A further advantage of the present invention is to provide an aeration system for aerating optimize air flow in a partially full storage bin, or to balance air flow between the upper and lower regions of a full storage bin.

A further advantage of the present invention is that it provides an aeration system for aerating particulate materials disposed in a storage bin that enables switching between a first mode of operation based on forced convection and a second mode of operation based on natural convection.

### BRIEF DESCRIPTION OF THE DRAWINGS

An embodiment of the invention is described below with reference to the accompanying drawings, in which:

FIGS. 1a to 1d are simplified block diagrams illustrating perspective views of an aeration system according to an embodiment of the invention;

FIGS. 2a to 2d are simplified block diagrams illustrating cross sectional views of the airflow in the storage bin generated by the aeration system according to an embodiment of the invention;

FIGS. 3a and 3b are simplified block diagrams illustrating a perspective front view and a perspective back view, respectively, of a bottom portion of an aerator of the aeration system according to an embodiment of the invention;

FIG. 3c is a simplified block diagram illustrating a perspective front view of an aerator of the aeration system according to an embodiment of the invention;

FIG. 3d is a simplified block diagram illustrating a cross sectional view of an aerator of the aeration system according to an embodiment of the invention;

FIGS. 3e and 3f are simplified block diagrams illustrating a perforated screen and a louvered screen, respectively, for use with the aerator of the aeration system according to an embodiment of the invention;

FIGS. 4a to 4c are simplified block diagrams illustrating a perspective view, a top view, and a cross sectional view, respectively, of an inlet port of the aeration system according to an embodiment of the invention;

FIGS. 4d and 4e are simplified block diagrams illustrating a perspective view of an airflow control mechanism in a closed and an open position, respectively, of the aeration system according to an embodiment of the invention;

FIG. 4f is a simplified block diagram illustrating a cross sectional view of the inlet port with an inlet airflow control mechanism; and

FIG. 5 is a simplified block diagram illustrating a cross sectional view of the venting tube of the aeration system according to another embodiment of the invention.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

While the description of certain embodiments herein below is with reference to an aeration system for aerating grain disposed in a storage bin, it will become evident to those skilled in the art that the embodiments of the invention are not limited thereto, but are also applicable for aerating numerous other stored particulate materials where a reduction in moisture content and/or a substantially equal temperature distribution within the stored particulate materials is desirable.

Furthermore, while the description of certain embodiments herein below is with reference to an aeration system for aerating grain disposed in a storage bin having a circular cross section, it will become evident to those skilled in the art that the embodiments of the invention are not limited thereto, but are also applicable for storage bins having other cross sections such as, for example, cross sections of square or rectangular shape.

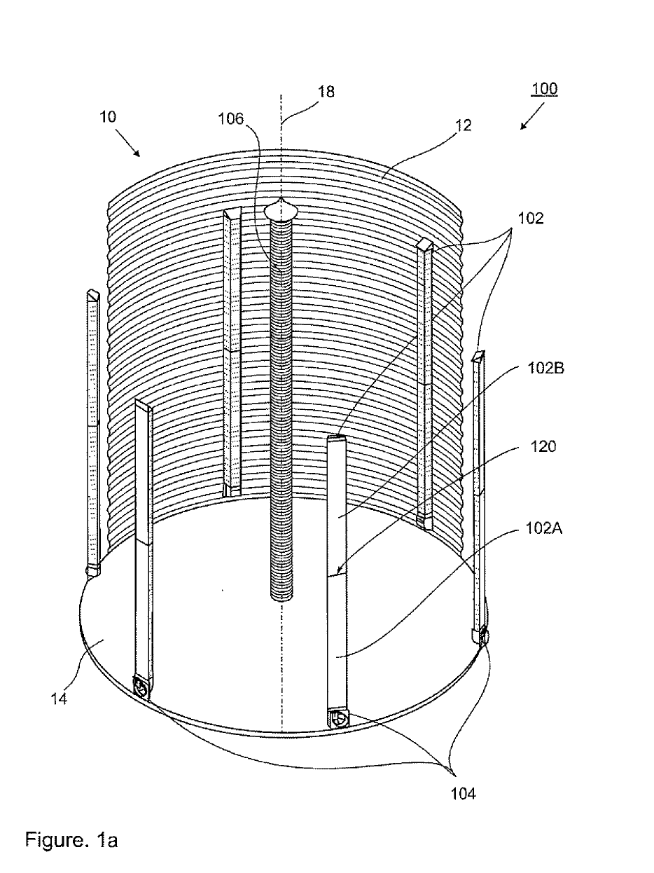

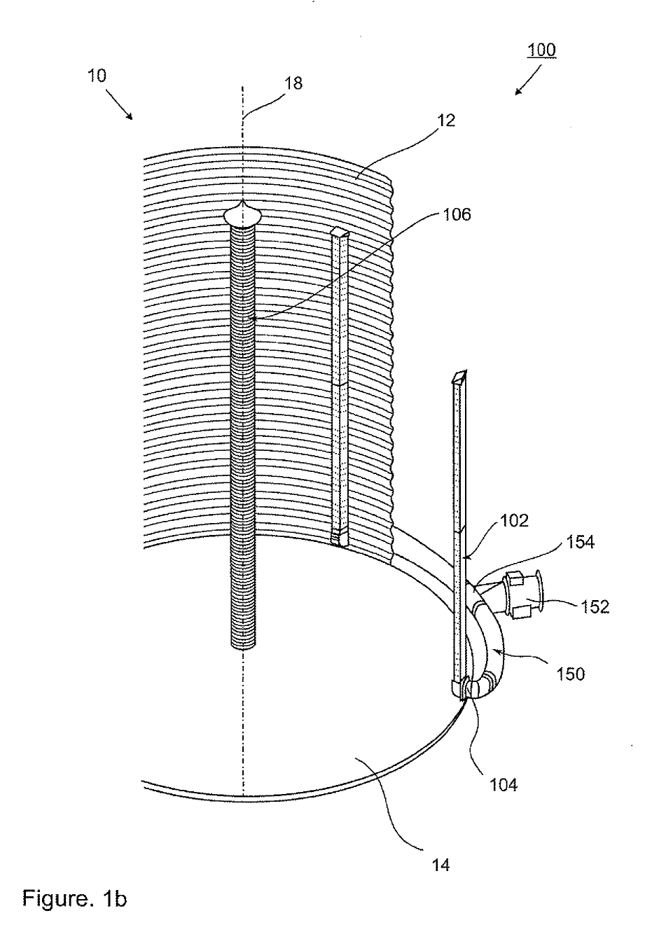

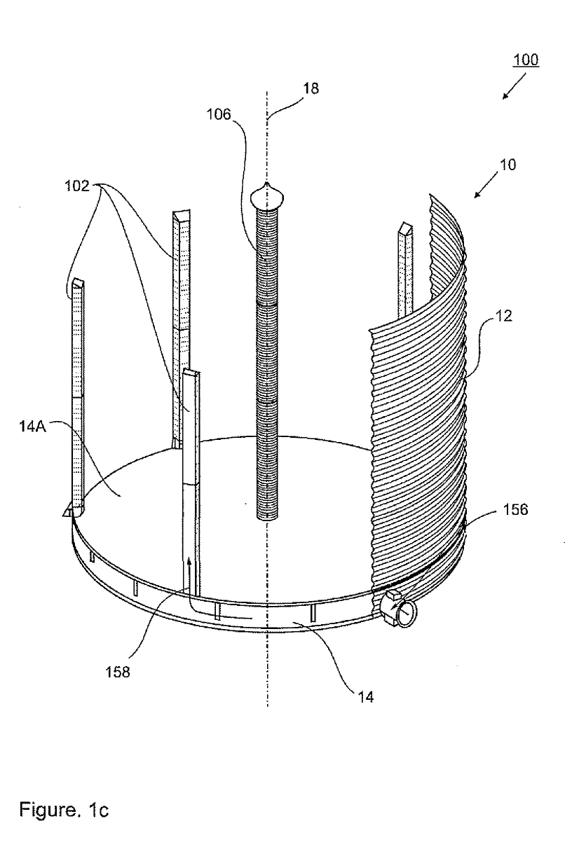

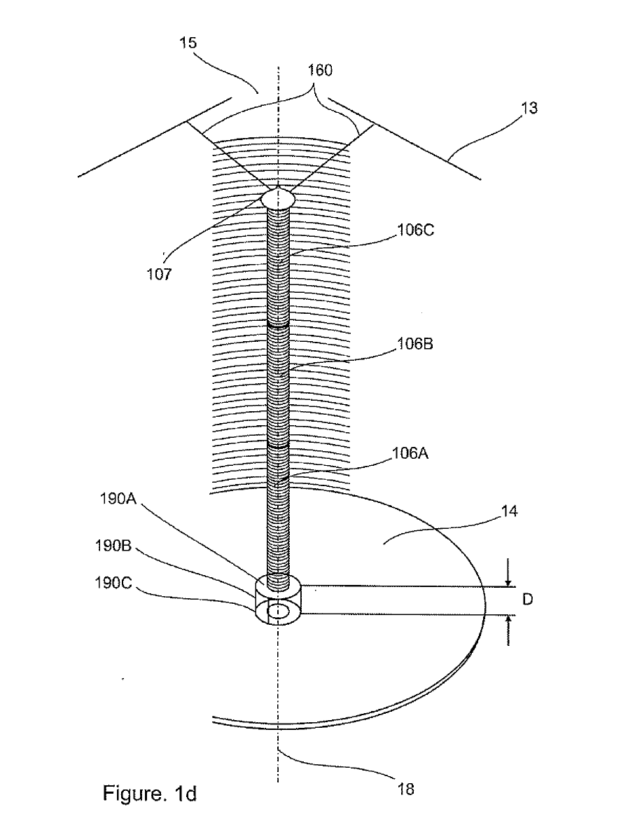

Referring to FIGS. 1a to 1d, a cross flow aeration system 100 for aerating grain disposed in a storage bin 10 according to an embodiment of the invention is provided. The aeration system 100 comprises a plurality of elongated hollow aerators 102 disposed inside a storage bin 10 in proximity to the inside surface of wall 12 thereof, in one case with the aerators 102 being mounted to the wall 12 such that the aerators 102 are structurally supported by the wall 12.

Each aerator 102 has at least an opening for transmitting air from inside the aerator 102 to the grain as will be described in more detail herein below. A bottom end portion of each aerator 102 comprises an inlet port 104 for providing fluid communication with a blowing mechanism 152. For example, the inlet ports 104 of the aerators 102 are connected to a supply conduit 150 which is connected to the blowing mechanism 152 via T-section 154, as illustrated in Figure lb. Alternatively, each aerator 102 has a blowing mechanism 152 directly connected to its inlet port 104. Further alternatively, the storage bin 10 comprises a raised floor 14A, as illustrated in FIG. 1c. Here, the inlet port 104 of each aerator 102 is connected to a space between the floor 14 and the raised floor 14A with the airflow being provided thereto by a blowing mechanism connected to inlet 156.

At least an aerator air flow control mechanism 120—for example, a damper as will be described in more detail herein below—may be disposed in each of the plurality of aerators 102 for controlling flow of the air between a bottom section 102A and a top section 102B thereof.

Optionally, the aerator air flow control mechanism 120 may be omitted, for example, for use in storage bins 10 having a height that is sufficiently small for properly aerating the grain disposed in the bottom portion of the storage bin 10, as will be described in more detail herein below.

An elongated perforated venting tube 106 is disposed at or in proximity of the center 18 of the storage bin 10 and oriented substantially vertical. The venting tube 106 is disclosed, for example, in U.S. Patent Application Publication No. 2011/0183597. The venting tube 106 has a length approximately equal to a distance between a bottom portion and a top portion of the storage bin 10 and has a plurality of apertures—such as, for example, the ones illustrated in

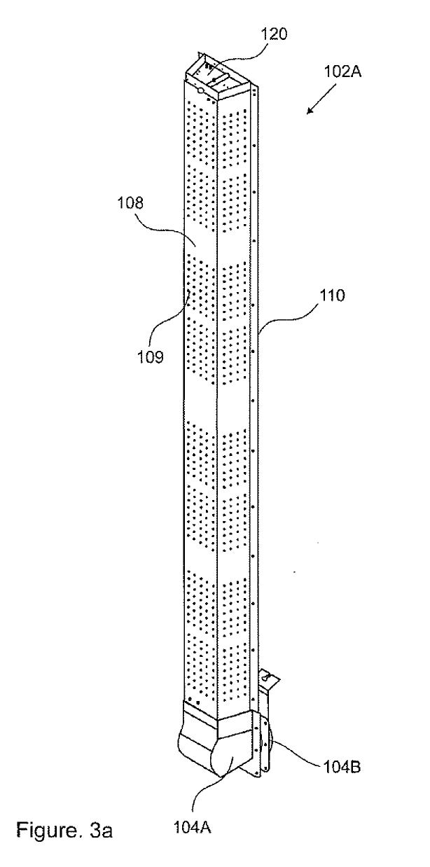

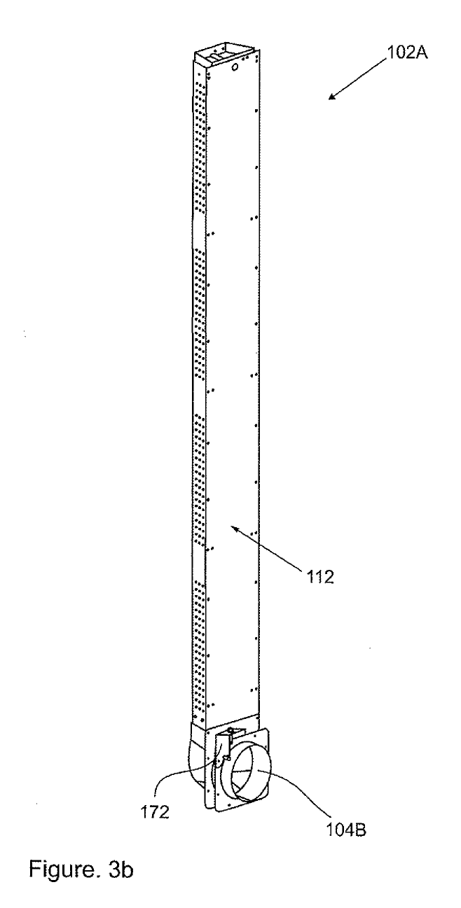

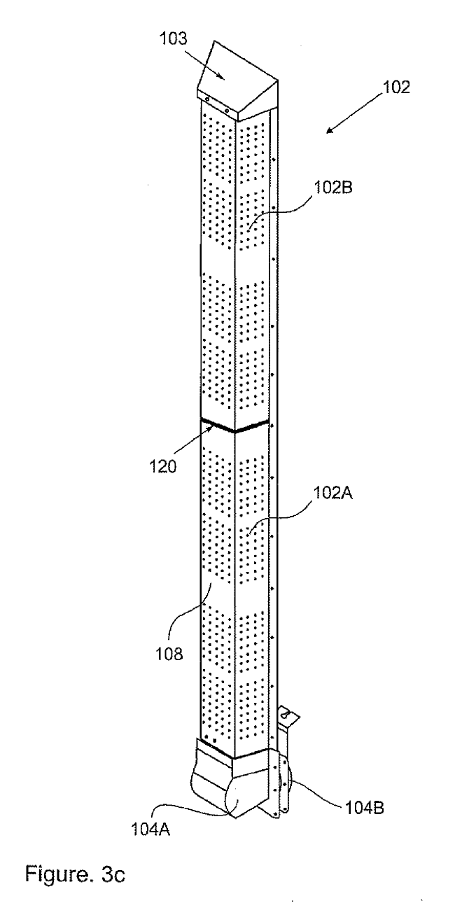

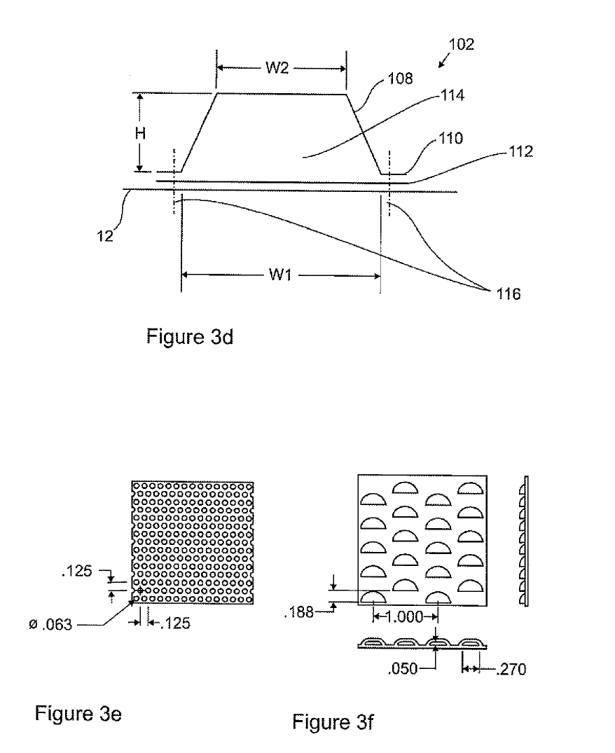

FIGS. 3e and 3f—for transmitting air from the particulate materials into the venting tube 106. The apertures may be approximately equally distributed along the length and circumference of the venting tube 106. An opening disposed in a top portion of the venting tube 106 enables transmitting the air from the inside of the venting tube 106 into a top portion of the storage bin 10 in proximity to storage bin opening 15 through natural convection. The top 107 of the venting tube 106 is mounted to the roof 13 of the storage bin 10 via, for example, chain links 160, as illustrated in Figure Id. The bottom end of the venting tube 106 is, for example, supported above the bin floor by means of a conventional support structure 190 comprising, for example, support plate 190A, support posts 190B and mounting ring 190C providing clearance

D between the bottom end of the venting tube 106 and the storage bin floor 14 for facilitating floor sweeping and/or for enabling access to an unload opening disposed in the center of center unload grain bins. Of course, the venting tube 106 may also be installed in storage bins having a hopper-type bottom as disclosed in U.S. Patent Application Publication No. 2011/0183597. The central aerator 106 may comprise a plurality of connected members such as members 106A, 106B, and 106C, for example, to facilitate transport and installation. The top 107 may be formed as a spreader cone in order to spread the grain when impinging thereupon during filling of the storage bin 10 through the opening 15, thus leaving the grain less packed to enable better movement of the air through the stored grain. Of course, the venting tube 106 is not limited to the circular cross section illustrated in FIG. 1d but various other cross section such as, for example, a hexagonal or square cross section are also implementable.

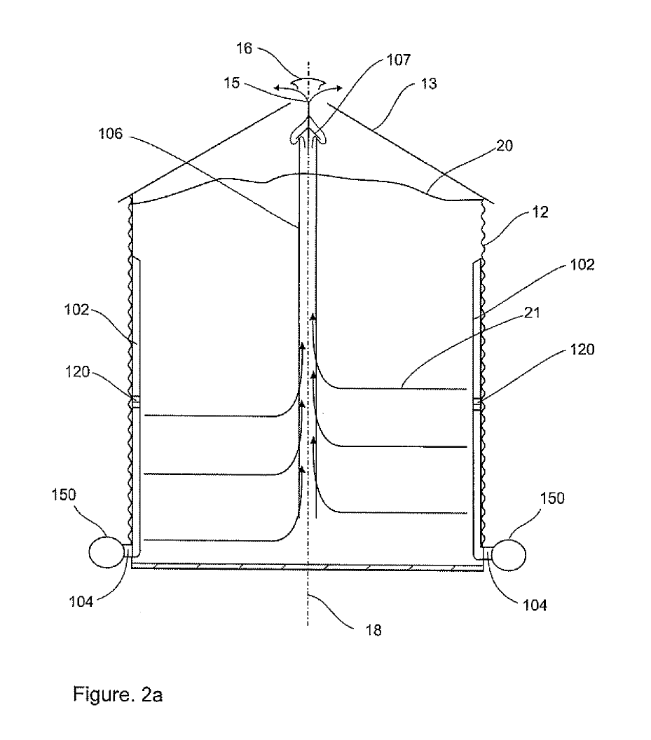

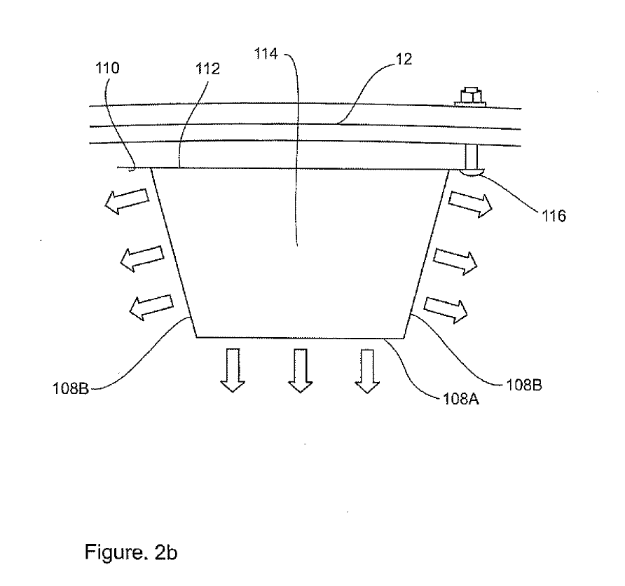

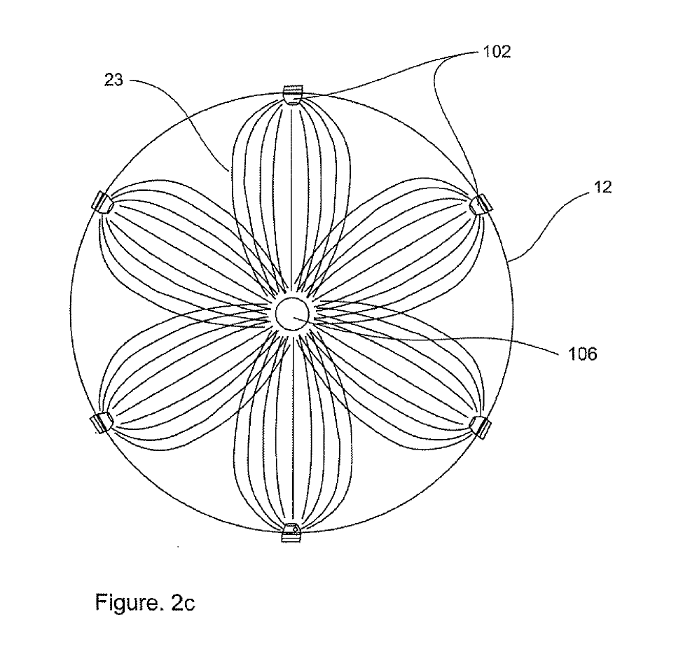

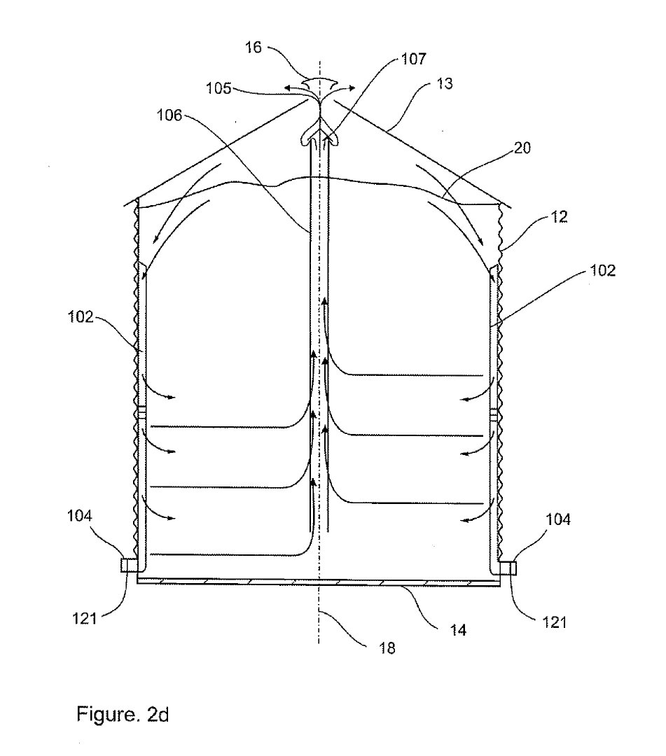

Referring to FIGS. 2a to 2c, a first mode of operation of the aeration system 100 is illustrated in a cross sectional side view, a detailed view of an aerator 102, and a cross sectional top view, respectively. Grain is disposed within the storage bin 10 to a fill level 20. Air provided by the blowing mechanism 152 to each of the aerators 102 is transmitted therefrom to the grain. Front section 108A of front member 108 of the aerator 102 may be oriented such that the air transmitted from openings disposed therein is transmitted in a direction substantially facing the venting tube 106, as illustrated in FIG. 2b. The transmitted air flows substantially horizontally through the grain from the aerator 102 to the venting tube 106, is transmitted therethrough to the bin roof, and vented therefrom through the opening 15 to a location external the storage bin 10. Side sections 108B of front member 108 of the aerator 102 may be oriented such that the air transmitted from openings disposed therein is transmitted in a direction oriented approximately parallel to the inside surface of the storage bin wall 12, as illustrated in FIG. 2b. The air transmitted therefrom flows substantially horizontally through the grain approximately parallel to the storage bin wall 12 followed by a gradual change of direction towards the venting tube 106 as indicated by line 23 in FIG. 2c. Of course, the front member 108 is not limited to the cross sectional shape illustrated in FIG. 2b but various other shapes such as, for example, a semi-circular shape are also implementable.

The aerators 102 may be disposed such that the distance between the aerators 102 is substantially equal to ensure approximately equal aeration of the grain with the distance therebetween determined such that sufficient aeration is provided throughout the stored grain in dependence upon: the size of the storage bin 10; the type of particulate materials stored; the size of the aerators 102; the static pressure of the airflow provided; and, the flow rate of the airflow provided.

The system 100 creates a short horizontally oriented air path from the aerators 102 to the venting tube 106, substantially reducing the static pressure of the provided airflow required—and consequently the power needed—to provide sufficient aeration throughout the stored grain.

Due to the weight of the grain the same is substantially more densely packed in the bottom portion of the storage bin 10 than in the top portion, in particular, in tall storage bins 10. Therefore, a higher static pressure of the airflow is required in the bottom portion than in the top portion resulting in substantially more air being transmitted to the grain in the top portion and insufficient aeration of the bottom portion. Therefore, at least an aerator air flow control mechanism 120—for example, a damper as will be described in more detail herein below—is disposed in each of the plurality of aerators 102 for controlling flow of the air between a bottom section 102A and a top section 102B thereof. The aerator air flow control mechanism 120 enables a controlled reduction of the airflow to the top section 102B to ensure sufficient aeration of the grain disposed in the bottom portion of the storage bin 10. Alternatively, the aerator air flow control mechanism 120 is in a closed position preventing airflow to the top section 102B to focus the aeration to the grain disposed in the bottom portion of the storage bin 10, or in case the storage bin 10 is only partially filled. Depending on the height of the storage bin 10 more than one aerator air flow control mechanism 120 may be disposed at different locations in each of the aerators 102.

Referring to FIG. 2d, a second mode of operation of the aeration system 100 is illustrated in a cross sectional side view. When the ambient temperature is significantly lower than the grain temperature an unequal temperature distribution within the stored grain is created with zones of lower temperature located in proximity to the outside walls of the storage bin 10 and zones of higher temperature located in proximity to the center 18 of the storage bin 10. The unequal temperature distribution causes cold air to move downward near the storage bin wall 12 and warmer air to rise in the center 18. This natural convection is enhanced by the aerators 102 transmitting the cold air downward from the top portion of the storage bin 10 to the bottom portion thereof and venting the warmer air through the venting tube 106. In this mode of operation the blowing mechanism 152 is shut off and, inlet air flow control mechanism 121 may be in a closed position.

Referring to FIGS. 3a to 3f, the aerator 102 according to one embodiment of the invention is shown. The aerator 102 comprises a back member 112 facing the inside wall 12 of the storage bin 10 and a front member 108 facing the center of the storage bin 10. The back member 112 may be shaped such that a portion of a contact surface of back member 112 is in touching contact with the wall 12 of the storage bin 10 for structural support when mounted thereto. In typical applications, the width WI of the contact surface of the back member 112 is substantially smaller than the diameter D of the storage bin 10, i.e. provision of a flat contact surface enables sufficient contact area for structural support of the aerator 102 by the wall 12 of the storage bin 10. The back member 112 is mounted to the wall 12 using, for example, machine screws through the bin wall at locations 116, as indicated in FIG. 3c, substantially facilitating installation. Optionally, apertures are disposed in the contact surface of the back member 112 at predetermined locations 110 for accommodating the machine screws therein. The front member 108 is mounted to the back member 112 at flanges 110 using, for example, sheet metal screws or a clamping mechanism. Optionally a sealing member is disposed between respective flanges of the back member 112 and the front member 108.

The openings 109 are sized such that airflow from inside 114 the aerator 102 to the particulate materials is enabled while transmission of the particulate materials into the aerator 102 is substantially prevented. For use with grain storage bins the aerator 102 may comprise a perforated screen 109 having round perforations in a staggered pattern and having the dimensions (in inches) as illustrated in FIG. 3e, or a louvered screen having the dimensions (in inches) as illustrated in FIG. 3f, but is not limited thereto. The perforations are provided using state of the art manufacturing processes such as CNC punching. Alternatively, the aerator 102 comprises larger openings disposed on the front member 108 with a screen having perforations of appropriate size. The screen is, for example, made from wire mesh of appropriate dimensions and mounted to the front member 108 using a supporting frame structure. Further alternatively, the perforations are disposed only on the front surface portion or the side surface portions of the front member 108.

Each of the aerators 102 may comprise a plurality of members, for example, a bottom member 102A and a top member 102B to facilitate transport and installation, particularly when employed as a retrofit. The shorter top and bottom members are more easily moved through a manhole of the storage bin 10 as well as handled inside the storage bin 10 during installation.

The back member 112, the front member 108, and cap 103 mounted to the top end of the top section 102B are made of, for example, commercially available sheet metal-appropriate steel such as galvanized steel or aluminum or suitable plastic material such as PVC using standard plastic molding techniques.

For example, the aeration system 100 has been implemented for aerating a grain storage bin 10 as illustrated in FIGS. 1a to 1d and 2a to 2d having a circular floor 14 with a diameter of approximately 16 feet and a wall 12 having a height of approximately 18 feet. Six aerators 102 are mounted to the inside surface of wall 12 of the storage bin 10 in an equidistant fashion. Each aerator 102 comprises a bottom member 102A and one or more top members 102B with each section having a length of 8 feet and cross sectional dimensions—as illustrated in FIG. 3c of: W1=8⅝ inches; W2=6 inches; and H=4⅞ inches. With these dimensions each section has an area of 760 square inches that can be perforated or louvered, resulting in a maximum open area of: 175 square inches using a 23% perforated screen; or 46 square inches using a 6% louvered screen. As is evident, other numbers of aerators 102 having different numbers of members and different dimensions are employable depending on the size and shape of the storage bin 10 as well as the type of particulate materials to be stored therein and the weather conditions—such as, for example, temperature and humidity—the storage bin is expected to be exposed to. The aeration system 100 is designed employing standard engineering technologies used for designing storage bins.

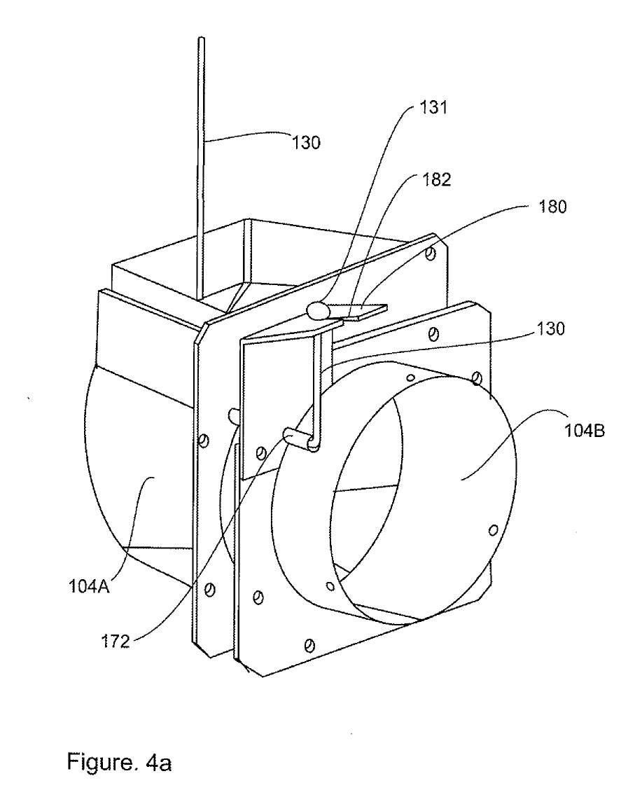

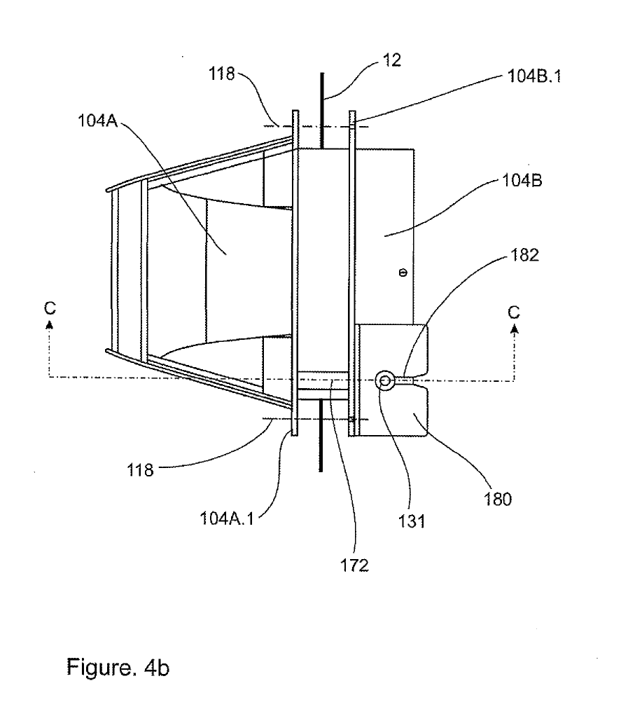

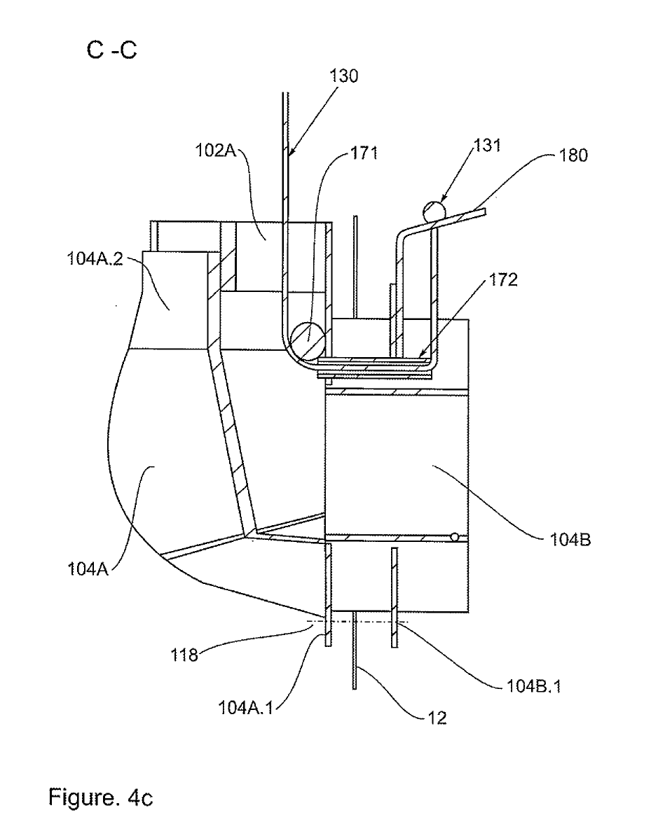

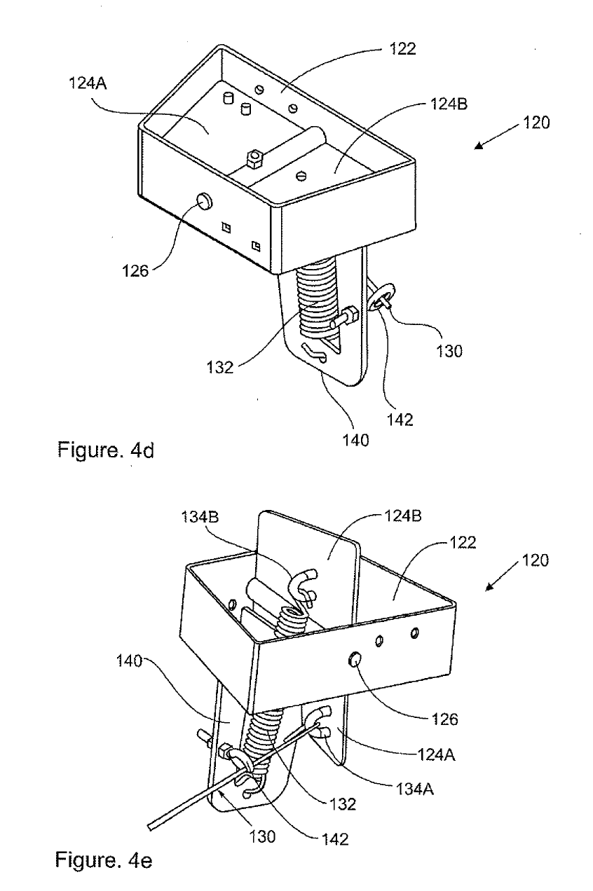

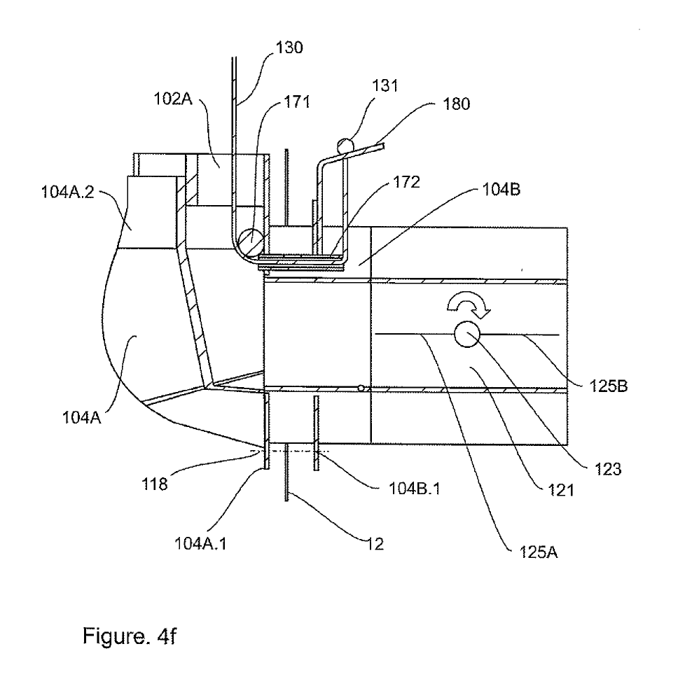

A bottom portion of each aerator 102 is connected to the inlet port 104, for example, as illustrated in FIGS. 4a to 4c, for providing the airflow to the aerator 102 through a respective opening disposed in a bottom portion of the wall 12 of the storage bin 10. The inlet port 104 may comprise an elbow section 104A mounted to the wall 12 inside the storage bin 10 and a connecting section 104B mounted to the wall 12 outside the storage bin 10 in conventional manner using, for example, screw bolts 118. For example, the elbow section 104A and the connecting section 104B each comprise a mounting plate 104A.1, 104B.1. For example, the elbow section 104A has an aperture and the connecting section 104B has an extension for being snugly accommodated in the aperture. The mounting plates 104A.1, 104B.1 are mounted to the wall 12 such that the extension of the connecting section 104B is accommodated in the opening disposed in the wall 12. Optionally, a sealing member is disposed between the mounting plates 104A.1, 104B.1 and the wall 12, respectively. The top portion 104A.2 of the elbow section 104A may comprise an inner cross section such that the bottom portion of the aerator 102 is accommodated therein via a snug fit to facilitate installation. Optionally, installation is further facilitated by providing an abutting structure for vertically abutting the bottom end of the aerator 102.

The aerator air flow control mechanism 120 disposed in the aerator 102 may be implemented as a damper operated via cable 130 as will be described in more detail hereinbelow. The cable 130 for operating the damper may be disposed inside the aerator 102 and then guided to the outside via cable guide 171 and cable guide tube 172, for example, mounted to the elbow section 104A and accommodated in the opening of the storage bin wall 12 and a respective aperture of the cover section mounting plate 104B.1. For example, a spring loaded damper is then simply opened by pulling knob 131 mounted to the cable 130. For holding the damper in the open position, the cable 130 is, for example, inserted in cable holding slot 182 of angled cable holding plate 180 which is mounted to the cover section mounting plate 1048.1. The pulling knob 131 is then abutted by the cable holding plate 180 due to the spring tension acting on the cable 130. Optionally, two or more knobs 131 are disposed at predetermined locations along an end portion of the cable 130 in order to enable partial opening of the damper. Of course, one skilled in the art will readily arrive at various different designs for opening and holding the damper in an open or partially open position. For example, the opening and holding the damper in an open or partially open position is also achieved by connecting the cable 130 to a conventional lever mechanism disposed outside the storage bin 10.

The supply conduit 150 may comprise a first supply conduit arm having a first portion of the plurality of aerators connected thereto and a second supply conduit arm having a second portion of the plurality of aerators 102 connected thereto. The first supply conduit arm and the second supply conduit arm are connected to the blowing mechanism 152 via T-section 154. The first supply conduit arm and the second supply conduit arm may have an approximately same length and an approximately same number of aerators 102 connected thereto. Provision of the two supply conduit arms enables a more equal distribution of the air provided by the blower 152 to the aerators 102. The supply conduit 150 can be manufactured using, for example, commercially available tubing, made of a suitable material such as, for example, sheet metal or plastic material. The T-section 154 and end caps are also commercially available. The tubing is rigid having a predetermined curvature to fit the curvature of the storage bin 10 or, alternatively, flexible tubing is employed which is bent appropriately to fit the curvature of the storage bin 10. The supply conduit 150 is, for example, mounted to the outside of the wall 12 of the storage bin 10 using commercially available fasteners. Alternatively, the inlet ports 104 are designed to have sufficient strength for supporting the weight of the supply conduit 150 mounted thereto.

Further alternatively, the supply conduit 150 is disposed inside the storage bin 10 in proximity of a bottom portion of the wall 12 having, for example, the aerators 102 directly connected thereto. The aerator air flow control mechanism 120 can be provided as a damper assembly forming a connecting element for connecting adjacent members of the aerator 102, as illustrated in FIGS. 3a, 4d and 4e. The damper assembly 120 comprises a ring structure 122 designed to fit the inside walls of the adjacent members of the aerator 102 for having the same mounted thereto in a conventional manner using, for example, sheet metal screws. Flaps 124A, 1248 are mounted to axle 126 which is pivotally movable mounted to the ring structure 122 in a conventional manner to enable movement of the flaps between a closed position and an open position as illustrated in FIGS. 4d and 4e, respectively. The flaps 124A, 124B can be held in the closed position using extension spring 132 connected to spring holding structure 140 and flap 124B via U-shaped mounting element 134B. In the closed position the flap 124B is then abutted on surface 144 of the spring holding structure 140. The cable 130 is mounted to the opposite flap 124A in a conventional manner via U-shaped mounting element 134A and guided via ring- shaped cable guide 142 mounted to the spring holding structure 140 in a conventional manner in a direction aligned with a longitudinal axis of the aerator 102. Pulling the cable 130 rotates the flaps 124A, 124B around axis 126 and extends the spring 132. Alternatively, a tension spring is employed with the tension spring being disposed co-axial to the axis 126 and mounted to the ring structure 122 at a first end and to one of the flaps 124A, 124B at a second opposite end.

Further alternatively, the cable 130 is disposed outside the aerator 102 inside or outside the storage bin 10. For example, a lever having the cable 130 attached thereto is mounted to the axle 126 outside the aerator 102 or outside the storage bin 10 with the axle 126 penetrating the back member 112 of the aerator 102 or also penetrating the wall 12 of the storage bin 10.

Of course, one skilled in the art will readily arrive at various different designs for providing the aerator air flow control mechanism 120 and operating the same. For example, the cable 130 is omitted by operating the damper using a solenoid actuator.

The inlet airflow control mechanism 121 may be disposed in the bottom end portion of the aerator 102 or the inlet port 104 and designed in a similar fashion as the airflow control mechanism 120. As illustrated in FIG. 4f, the inlet airflow control mechanism 121 comprises flaps 125A, 125B mounted to axle 123 which is pivotally movable mounted to the inlet port 104 in a conventional manner to enable movement of the flaps between a closed position and an open position. The inlet airflow control mechanism 121 is operated in a similar fashion as the airflow control mechanism 120, i.e. manually or using a solenoid actuator.

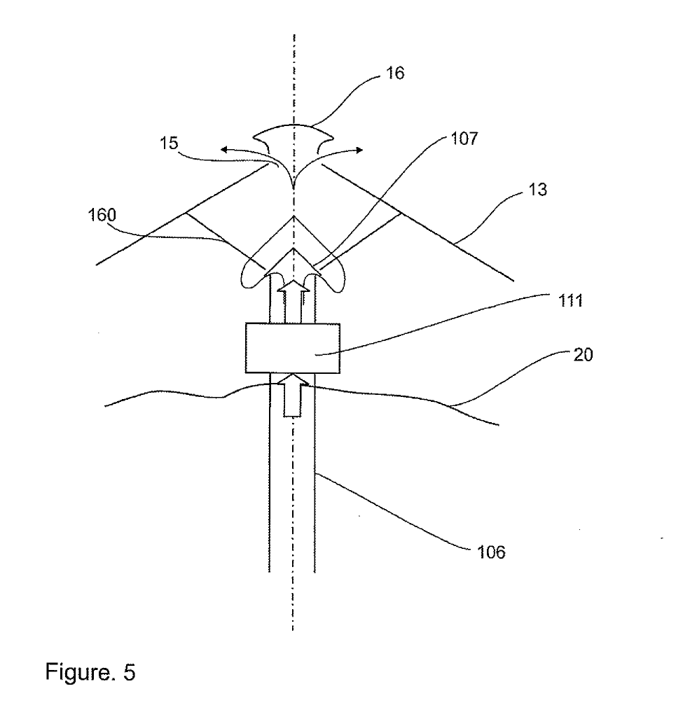

Optionally, a suction mechanism 111 such as an electrically driven fan is disposed in the top end portion of the venting tube 106 in a conventional manner, as illustrated in FIG. 5. The suction mechanism 111 provides suction to the venting tube 106 and exhausts the air below the cap 107 in order to, for example, enhance the airflow through the stored grain when the aeration system 100 is in the second mode of operation. Power is provided, for example, via an electrical cable attached to one of the chain links 160 or to the venting tube 106.

The present invention has been described herein with regard to certain embodiments. However, it will be obvious to persons skilled in the art that a number of variations and modifications can be made without departing from the scope of the invention as described herein.

1. A method of storing and aerating particulate material comprising:
locating the particulate material in a storage bin having an upstanding peripheral wall and a bin roof on top of the peripheral wall;
mounting a plurality of upstanding elongated hollow aerator ducts inside the storage bin in proximity to the peripheral wall at angularly spaced positions around the peripheral wall;
providing on each aerator duct perforations for transmitting air from inside the aerator duct to the particulate materials within the storage bin;
mounting an elongate perforated venting tube approximately centrally within the storage bin, the venting tube extending generally through the particulate material upwardly toward the bin roof;
collecting within the venting tube the air from the particulate materials and transmitting and venting the same;
driving exterior air by an air blower arrangement into the hollow aerator ducts so as to pass through the hollow aerator ducts and from the aerator ducts through the particulate material to the venting tube and through the venting tube;
causing substantially all of said air exterior to said storage bin from said air blower arrangement to pass into the particulate material through said aerator ducts by connecting the air blower arrangement to the aerator ducts by one or more supply conduits;
and causing air from the air blower arrangement to enter the elongate perforated venting tube substantially only by passage through the particulate material from the aerator ducts.

2. The method according to claim 1 wherein the venting tube extends into a space between the particulate material and the bin roof.

3. The method according to claim 1 wherein the venting tube discharges into a space between the particulate material and the bin roof and escapes from the bin roof.

4. The method according to claim I wherein the venting tube has an open upper end underneath a filling opening at a center of the bin roof with a cover over the open upper end.

5. The method according to claim 1 wherein said one or more supply conduits is connected to a bottom portion of each of the aerator ducts.

6. The method according to claim 1 wherein each of the aerator ducts comprises a rear wall in contact with the peripheral wall of the storage bin for structural support thereby.

7. The method according to claim 1 wherein each of the aerator ducts comprises a rear wall facing the peripheral wall of the storage bin and a front member facing into the particulate material.

8. The method according to claim 1 wherein each of said aerator ducts has a perforated front wall arranged to transmit said air in a direction toward a center of the storage bin.

9. The method according to claim 1 wherein said perforations in each aerator duct for transmitting air from inside the aerator duct to the particulate materials within the storage bin terminate at a position below a fill level of the particulate material.

10. The method according to claim 1 wherein a bottom end of the venting tube is located at a height above a bottom surface of the storage bin on which the particulate material sits.

11. The method according to claim 1 wherein an aerator air flow control mechanism is disposed in each of the plurality of aerator ducts for controlling flow of the air between a bottom section and a top section thereof.

12. A method of storing and aerating particulate material comprising:
locating the particulate material in a storage bin having an upstanding cylindrical peripheral wall and a bin roof on top of the peripheral wall;
mounting a plurality of upstanding elongated hollow aerator ducts disposed inside the storage bin in proximity to the cylindrical peripheral wall at angularly spaced positions around the cylindrical peripheral wall;
mounting the upstanding aerator ducts only at the cylindrical peripheral wall and having no portion of the aerator ducts on the bin bottom;
providing in each aerator duct perforations for transmitting air from inside the aerator duct to the particulate materials within the storage bin;
driving exterior air by an air blower arrangement into the hollow aerator ducts so as to pass through the hollow aerator ducts and from the aerator ducts through the particulate material to the venting tube and through the venting tube into the roof space;
causing substantially all of said air exterior to said storage bin from said air blower arrangement to pass into the particulate material through said aerator ducts and to escape from the particulate material into the roof space by connecting the air blower arrangement to the aerator ducts by one or more supply conduits;
and causing said air from said aerator ducts to move in a direction toward a center of the storage bin by passing through a perforated front wall of the ducts.

13. The method according to claim 12 wherein said one or more supply conduits is connected to a bottom portion of each of the aerator ducts.

14. The method according to claim 12 wherein each of the aerator ducts comprises a rear wall in contact with the peripheral wall of the storage bin for structural support thereby.

15. The method according to claim 12 wherein said perforations in each aerator duct for transmitting air from inside the aerator duct to the particulate materials within the storage bin terminate at a position below a fill level of the particulate material.

16. The method according to claim 12 wherein an aerator air flow control mechanism is disposed in each of the plurality of aerator ducts for controlling flow of the air between a bottom section and a top section thereof.

17. A method of storing and aerating particulate material comprising:
locating the particulate material in a storage bin having an upstanding cylindrical peripheral wall and a bin roof on top of the peripheral wall;
mounting a plurality of upstanding elongated hollow aerator ducts disposed inside the storage bin in proximity to the cylindrical peripheral wall at angularly spaced positions around the cylindrical peripheral wall;
mounting the upstanding aerator ducts only at the cylindrical peripheral wall and having no portion of the aerator ducts on the bin bottom;
providing in each aerator duct perforations for transmitting air from inside the aerator duct to the particulate materials within the storage bin;
driving exterior air by an air blower arrangement into the hollow aerator ducts so as to pass through the hollow aerator ducts and from the aerator ducts through the particulate material to;
causing substantially all of said air exterior to said storage bin from said air blower arrangement to pass into the particulate material through said aerator ducts and to escape from the particulate material into the roof space by connecting the air blower arrangement to the aerator ducts by one or more supply conduits;
causing all of the air passing into the particulate material from the aerator ducts to escape from a top surface of the particulate material into the roof space by providing no air transfer duct located in the bin at a position within the particulate material;
and causing said air from said aerator ducts to move in a direction toward a center of the storage bin by passing through a perforated front wall of the ducts.
